(19) United States
(12) Patent Application Publication
(10) Pub. No.: US 2003/0200479 A1
(43) Pub. Date: Oct. 23, 2003

(54) Advanced method for data backup

(76) Inventor: Steffan Bansemer, Berlin (DE)

Correspondence Address: Steffan Bansemer, Regattastr. 60, 12527 Berlin, DE

(21) Appl. No.: 10/124,420

(22) Filed: Apr. 18, 2002

(51) Int. Cl. G06F 11/00

(52) U.S. Cl. 714/6

(57) ABSTRACT

This method for data backup provides a way for computer users to easily backup important and personal data. It offers backup task templates for data that should be scheduled for backups and detects the need to update an according backup archive. The method includes a) offering backup task templates that contain title and information about data to backup b) create a permanent backup task file with these information c) detect the need to update the backup archive when data have been changed or modified.

### FIELD OF THE INVENTION

This invention relates generally to a software application, and more particularly to methods for supporting a computer user to permanent backup important data and prevent the loss of data or users productivity.

### BACKGROUND OF THE INVENTION

Common users of computers do not know what kind of files and data should be scheduled for a backup or where to find them, what their name or type is. This method will support users with a range of possible templates to easy setup/create one or more permanent backup tasks. These templates can be designed for eg “Word Documents”, “Excel” files, Internet-Settings, E-Mail data and so on. This method too shows to the user what kind of data could be important for him and on the other frees him from searching/collecting data that must be scheduled for a backup because a template file contains all this information. The User than can run a backup at any time with all created backup tasks and do not need to collect data for each backup process anymore.

### SUMMARY OF THE INVENTION

According to the present invention, this method uses templates files to create permanent backup tasks. These permanent tasks are used to verify files and data scheduled for backup and run a backup if it is necessary. The User can select one or more template to create backup tasks for his needs. A backup task template contains information about the files and data that will be scheduled for a backup process when selecting that template. The software application checks backup tasks and verify the need of running a new backup process—at any time.

What is claimed is:

1. A method comprising:
a software application offers a set of backup task templates;
a backup task template is a file that contains a title and a description for the user and data for that software application, what kind or types of files or data will be scheduled for backup when using this template to create a permanent backup task;
when the user of the software application selects a backup task template a permanent backup task file will be created supported with the data stored in that backup task template;
a permanent backup task contains information about data and files the user wants to backup periodical;
if a backup process is initiated by the user or automatically, the software application checks the backup task and verifies if any file or data has been changed or modified, that have been scheduled for backup with this backup task;
if files or data changed, scheduled for backup process, the software application will update the according backup archive with new or modified data or files;

2. The method of claim 1 wherein the user of the software application can use more than one backup task template to create a permanent backup task.

3. The method of claim 1 wherein the user of the software application can create more than one permanent backup task with that software application.
